(19) United States
(12) Patent Application Publication
(10) Pub. No.: US 2023/0052037 A1
(43) Pub. Date: Feb. 16, 2023

(54) METHOD AND APPARATUS FOR IDENTIFYING PARTITIONS ASSOCIATED WITH ERRATIC PEDESTRIAN BEHAVIORS AND THEIR CORRELATIONS TO POINTS OF INTEREST

(71) Applicant: HERE Global B.V., Eindhoven (NL)

(72) Inventors: Jerome BEAUREPAIRE, Berlin (DE); Gianpietro BATTISTUTTI, Berlin (DE)

(21) Appl. No.: 17/401,891

(22) Filed: Aug. 13, 2021

(51) Int. Cl. B60W 60/00; G06K 9/00; G06K 9/32; G01C 21/00

(52) U.S. Cl. CPC B60W 60/001; G06K 9/00369; G06K 9/00791; G06K 9/3233; G01C 21/3822; G01C 21/387; B60W 2420/42; B60W 2554/4029

(57) ABSTRACT

An approach is provided for identifying partitions associated with erratic pedestrian behaviors and their correlations to points of interest. For example, the approach involves receiving sensor data associated with a geographic area. The approach also involves based on the sensor data, determining pedestrian-behavior parameter(s) respectively for partition(s). Each respective partition of the partition(s) represents a respective subarea of the geographic area, a respective time period, or a combination thereof. The approach further involves identifying at least one erratic partition from the partition(s) based on determining that a respective pedestrian-behavior parameter associated with the at least one erratic partition deviates from a baseline pedestrian-behavior parameter by at least a threshold extent. The approach further involves determining a correlation of the at least one erratic partition to at least one map feature of a geographic database. The approach further involves providing the correlation as an output.

### BACKGROUND

Pedestrian risky behaviors, such jaywalking, walking and looking at smart phones, etc. can result in traffic accidents and require more preventive strategies considering the increasing popularity of autonomous vehicles. Although autonomous vehicles can be equipped with advanced sensors (e.g., Light Imaging Detection and Ranging (Lidar) sensors, infrared sensors, etc.) to detect and react to risky pedestrian behaviors, such unexpected pedestrian behaviors still surprise users of the autonomous vehicles. Accordingly, there are significant technical challenges to predict risky pedestrian behaviors and mitigate the impacts of such pedestrian behaviors.

### SOME EXAMPLE EMBODIMENTS

As a result, there is a need for an approach for identifying spatial partitions (e.g., a road segment near a train station) and/or temporal partitions (e.g., soccer practice hour(s)) associated with erratic pedestrian behaviors (e.g., bus catching, jaywalking, etc.) and their correlations to points of interest in a geographic area, in order to adjust operations of vehicles, points of interest, city planning, etc.

According to example embodiment(s), a computer-implemented method comprises receiving, by one or more processors from one or more sensors, sensor data associated with a geographic area. The method also comprises based on the sensor data, determining, by the one or more processors, one or more pedestrian-behavior parameters respectively for one or more partitions. Each respective partition of the one or more partitions represents a respective subarea of the geographic area, a respective time period, or a combination thereof. The method further comprises identifying, by the one or more processors, at least one erratic partition from the one or more partitions based on determining that a respective pedestrian-behavior parameter associated with the at least one erratic partition deviates from a baseline pedestrian-behavior parameter by at least a threshold extent. The method further comprises determining, by the one or more processors, a correlation of the at least one erratic partition to at least one map feature of a geographic database. The method further comprises providing, by the one or more processors, the correlation as an output.

According to another embodiment, an apparatus comprises at least one processor, and at least one memory including computer program code for one or more programs, the at least one memory and the computer program code configured to, with the at least one processor, to cause, at least in part, the apparatus to receive, from one or more sensors, sensor data associated with a geographic area. The apparatus is also caused to, based on the sensor data, determine one or more pedestrian-behavior parameters respectively for one or more partitions. Each respective partition of the one or more partitions represents a respective subarea of the geographic area, a respective time period, or a combination thereof. The apparatus is further caused to identify at least one erratic partition from the one or more partitions based on determining that a respective pedestrian-behavior parameter associated with the at least one erratic partition deviates from a baseline pedestrian-behavior parameter by at least a threshold extent. The apparatus is further caused to determine a correlation of the at least one erratic partition to at least one map feature of a geographic database. The apparatus is further caused to provide the correlation as an output.

According to another embodiment, a computer-readable storage medium carrying one or more sequences of one or more instructions which, when executed by one or more processors, cause, at least in part, an apparatus to receive, from one or more sensors, sensor data associated with a geographic area. The apparatus is also caused to, based on the sensor data, determine one or more pedestrian-behavior parameters respectively for one or more partitions. Each respective partition of the one or more partitions represents a respective subarea of the geographic area, a respective time period, or a combination thereof. The apparatus is further caused to identify at least one erratic partition from the one or more partitions based on determining that a respective pedestrian-behavior parameter associated with the at least one erratic partition deviates from a baseline pedestrian-behavior parameter by at least a threshold extent. The apparatus is further caused to determine a correlation of the at least one erratic partition to at least one map feature of a geographic database. The apparatus is further caused to provide the correlation as an output.

According to another embodiment, an apparatus comprises means for receiving, from one or more sensors, sensor data associated with a geographic area. The apparatus also comprises means for based on the sensor data, determining one or more pedestrian-behavior parameters respectively for one or more partitions. Each respective partition of the one or more partitions represents a respective subarea of the geographic area, a respective time period, or a combination thereof. The apparatus further comprises means for identifying at least one erratic partition from the one or more partitions based on determining that a respective pedestrian-behavior parameter associated with the at least one erratic partition deviates from a baseline pedestrian-behavior parameter by at least a threshold extent. The apparatus further comprises means for determining a correlation of the at least one erratic partition to at least one map feature of a geographic database. The apparatus further comprises means for providing the correlation as an output.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of identifying partitions associated with erratic pedestrian behaviors and their correlations to points of interest, according to example embodiment(s);

FIG. 2A depicts diagrams of example spatial and/or temporal partition(s) associated with erratic pedestrian behavior(s), according to example embodiment(s);

FIG. 2B is a diagram of a map user interface depicting example partitions associated erratic pedestrian behaviors, according to example embodiment(s);

FIG. 2C is a flowchart of a process for applying partitions/correlations associated with erratic pedestrian behaviors, according to example embodiment(s);

FIG. 3 is a diagram of the components of a mapping platform, according to example embodiment(s);

FIG. 4 is a flowchart of a process for identifying partitions associated with erratic pedestrian behaviors and their correlations to points of interest, according to example embodiment(s);

FIG. 5 is a diagram of an example machine learning data matrix, according to one or more example embodiments;

FIGS. 6A-6B are diagrams illustrating example vehicle user interfaces for displaying and/or mitigating partition(s) associated with erratic pedestrian behaviors, according to example embodiment(s);

FIGS. 7A-7B are diagrams illustrating example user interfaces for displaying and/or mitigating partition(s) associated with erratic pedestrian behaviors for users outsides of vehicles, according to example embodiment(s);

FIG. 8 is a diagram of a geographic database, according to example embodiment(s);

FIG. 9 is a diagram of hardware that can be used to implement an embodiment of the invention, according to example embodiment(s);

FIG. 10 is a diagram of a chip set that can be used to implement an embodiment of the invention, according to example embodiment(s); and

FIG. 11 is a diagram of a mobile terminal (e.g., handset or vehicle or part thereof) that can be used to implement an embodiment.

### DESCRIPTION OF SOME EMBODIMENTS

Examples of a method, apparatus, and computer program for identifying partitions associated with erratic pedestrian behaviors and their correlations to points of interest are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

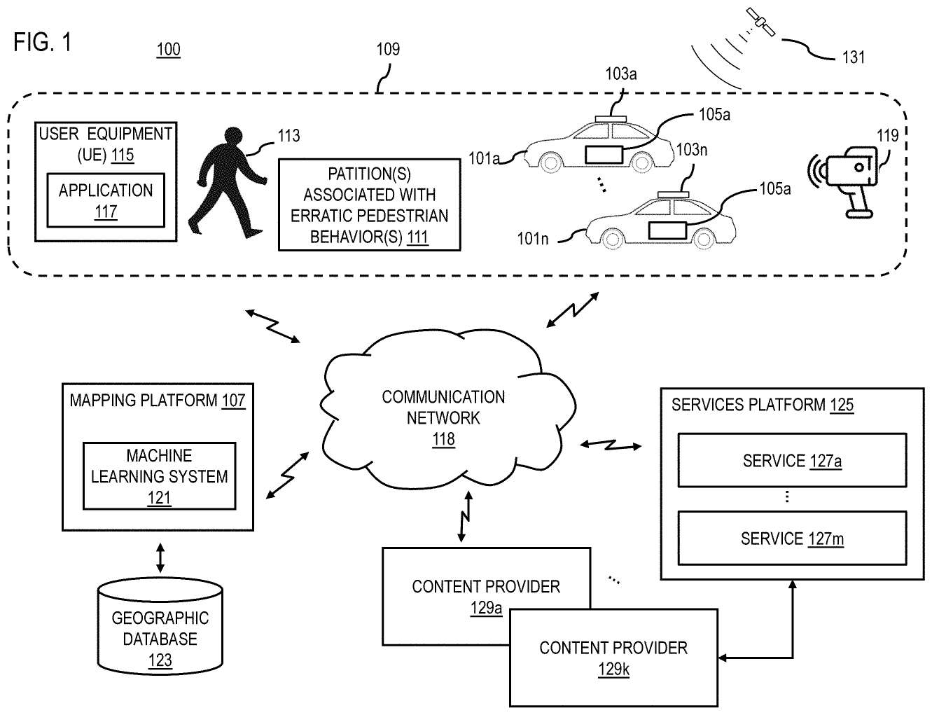

FIG. 1 is a diagram of a system capable of identifying partitions associated with erratic pedestrian behaviors and their correlations to points of interest, according to example embodiment(s). There exists certain erratic pedestrian behaviors that when spotted or detected in a road or travel network, there is a high chance of accidents. Example of these erratic pedestrian behaviors include bus jaywalking, catching, crossing at red lights, etc.

At the same time, as discussed above, service providers and manufacturers who are developing vehicle safety technologies, particularly technologies used in autonomous or highly assisted driving vehicles, are challenged to improve safety (e.g., avoiding collisions with pedestrians and animals in the roadway) while also making traffic flow smoothly. For example, vehicles can be equipped with sensors ranging from simple and low cost sensors (e.g., camera sensors, light sensors, etc.) to highly advanced and often very expensive sensors such as Light Imaging Detection and Ranging (Lidar) sensors, Radio Detection and Ranging (Radar), infrared sensors, and the like. Although these vehicle sensors can detect and react to risky pedestrian behaviors, such unexpected pedestrian behaviors still surprise users of the autonomous vehicles (AVs).

To address these technical problems, a system 100 of FIG. 1 introduces a capability to identify partitions 111 associated with erratic pedestrian behaviors in a geographic area thereby adjusting operations of vehicles, points of interest, city planning, etc. to mitigate impacts of an erratic pedestrian behavior in real time or after entering into a geographic area or region that is known historically to have erratic pedestrian behaviors (e.g., as identified). For instance, the partitions 111 can include spatial partitions (e.g., a road segment near a train station) and/or temporal partitions 111 (e.g., soccer practice hour(s)) associated with erratic pedestrian behaviors occurring on a road segment.

As shown in FIG. 1, the system 100 comprises vehicles 101a-101n (also collectively referred to as vehicles 101) configured with one or more sensors 103a-103n (also collectively referred to as sensors 103). In one embodiment, the vehicles 101 are autonomous vehicles or highly assisted driving vehicles that are capable of sensing their environments and navigating within travel network 109 without driver or occupant input. It is noted that autonomous vehicles and highly assisted driving vehicles are part of a spectrum of vehicle classifications that can span from no automation to fully autonomous operation. For example, the U.S. National Highway Traffic Safety Administration (“NHTSA”) in its “Preliminary Statement of Policy Concerning Automated Vehicles,” defines six levels of vehicle automation. In one embodiment, the various embodiments described herein are applicable to vehicles 101 that are classified as traditional vehicles, and/or in any of the levels of automation (levels 0-5). autonomous vehicles are able to drive themselves without the input of vehicle passengers or occupants, via sensors to measure conditions outside the vehicles, such as vision, LiDAR (Light Detection And Ranging), radar, ultrasonic range, Global Positioning System (GPS), etc. The advanced driver assist systems (ADAS) usually control vehicle trajectories using configurations (e.g., vehicle speeds, acceleration rates, braking rates, etc. under different scenarios) based on map data and/or sensor data obtained via using sensor systems and V2X communication. With the information, the vehicles generally can react to changing situations.

By way of example, the system 100 can process sensor data collected by vehicles 101 to identify incidents of erratic pedestrian behaviors using pedestrian-behavior parameters. In one embodiment, a given pedestrian-behavior parameter can correspond to a digital measurement or representation of a particular erratic pedestrian behavior type (e.g., jaywalking, bus/train catching, red-light running, inattentive due to nightlife events, distracted by user devices, distracted by POIs, etc.). For instance, jaywalking occurs when a pedestrian walks in or crosses a roadway that has traffic, other than at a suitable crossing point, or otherwise in disregard of traffic rules. As such, jaywalking parameters can include crossing position/speed/traffic on a road link per incident. As another instance, bus catching occurs when a pedestrian running in or crosses a lane that a bus is on. As such, bus catching parameters can include speed/traffic on a road lane per incident. The system 100 can determine and aggregate incidents of erratic pedestrian behaviors into spatial and/or temporal erratic partitions, and corelate the erratic partitions with location(s), such as POI(s) or a vicinity of the POI(s), of map feature(s) as follows.

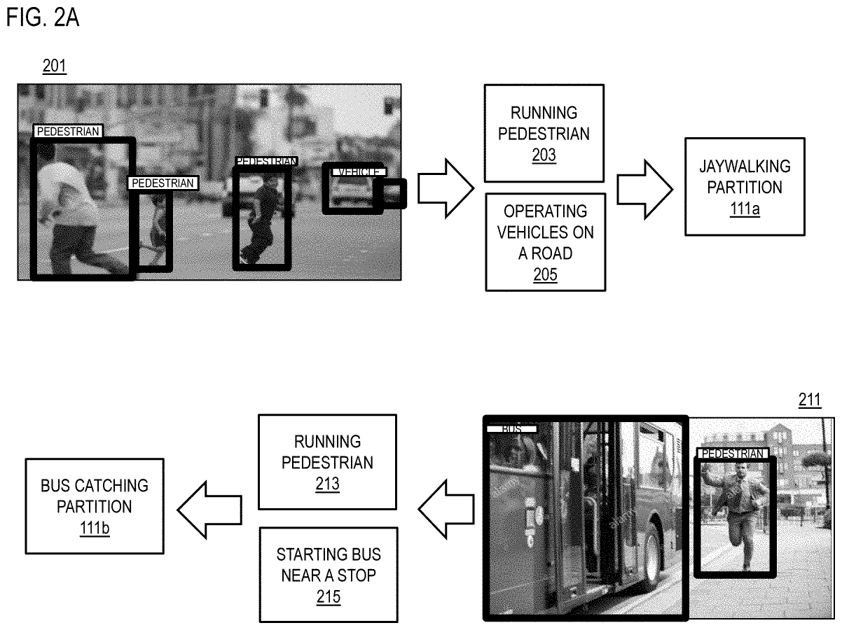

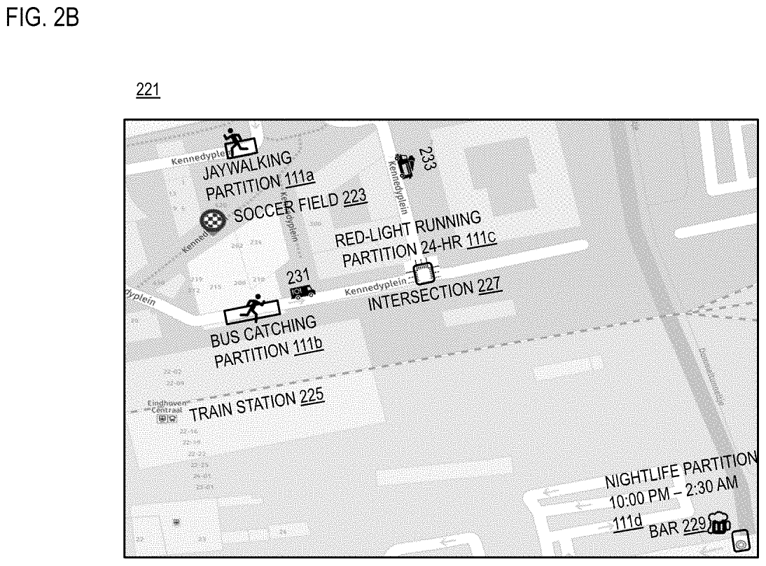

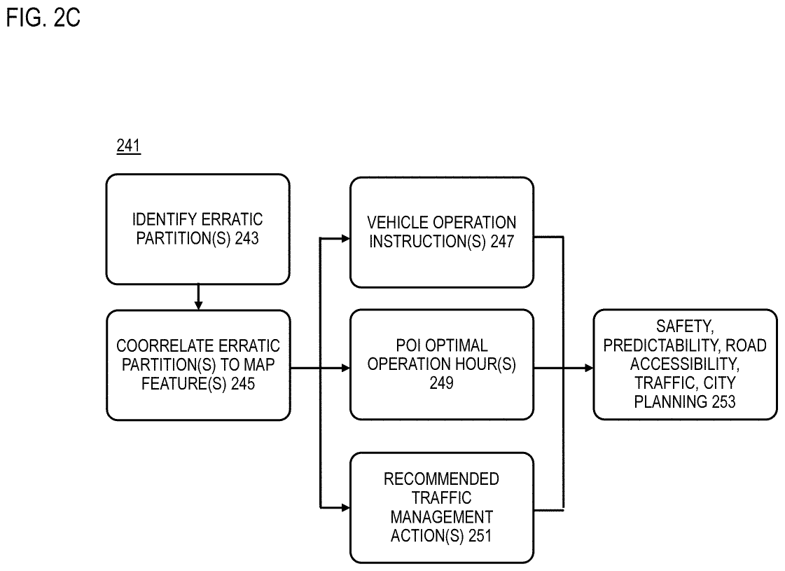

FIG. 2A depicts diagrams of example spatial and/or temporal partition(s) associated with erratic pedestrian behavior(s), according to example embodiment(s). In FIG. 2A, the system 100 can apply computer vision on image data 201, 211 (e.g., photos, videos, etc. collected via camaras) and identify objects in boxes, such as pedestrians, vehicles, etc. In addition, the system 100 can use radar data and/or LiDAR data to determine object distances and speeds. With the object type, distance and speed information, the system 100 can determine that there are three pedestrians 203 running across a road while many vehicles driving thereon 205, i.e., three jaywalking incidents at a point of time on a road segment based on location sensor data from the vehicles 101.

For instance, the system 100 can aggregate jaywalking incidents per road segment, per road, per partition, per map tile, per zip code, per area (e.g., town, city, etc.), etc. When the incident count reaches a threshold value, the system 100 can assign the corresponding road segment, road, partition, area, etc., as an erratic road segment, road, partition, area, etc., such as a jaywalking partition 111a. By analogy, a bus chasing partition 111b can be determined based on bus chasing incidents identified by the system 100 via detecting jaywalking incidents (e.g., incidents of one pedestrian 213 chasing after a departing bus 215 at a point of time on a road segment).

In another embodiment, the system 100 can detect jaywalking incidents based on probe data. Each UE 115 is carried by a pedestrian and configured to report probe data as probe points, which are individual data records collected at a point in time that records telemetry data for that point in time. In one embodiment, the probe ID can be permanent or valid for a certain period of time. In one embodiment, the probe ID is cycled, particularly for consumer-sourced data, to protect the privacy of the source. In one embodiment, a probe point can include attributes such as: (1) probe ID, (2) longitude, (3) latitude, (4) altitude, (5) heading, (6) speed, and (7) time. The list of attributes is provided by way of illustration and not limitation. Accordingly, it is contemplated that any combination of these attributes or other attributes may be recorded as a probe point.

In one embodiment, the system 100 can use criteria for collecting/retrieving pedestrian probe data as within a threshold of a POI (e.g., a school), and determine erratic pedestrian behaviors as associated with the POI based on contextual data and/or machine learning. For instance, the system 100 can collect/retrieve pedestrian probe data in a direct vicinity from the POI (e.g., 500 meters or isoline 5 minutes), pedestrian probe data of people going to the POI, look at the trajectory to see start/end at the POI, etc. In one embodiment, based on heuristics and/or machine learning, the system 100 can decide how many incident observations are sufficient to make a generalization of the pedestrian behavior pattern or pattern check to recognize an erratic behavior/pattern/partition. Referring back to the school example, the system 100 can generate/build a personalize model for the school—home pedestrian behavior/pattern/partition overtime.

In one embodiment, the system 100 can characterize pedestrian behaviors based on probe density, speed, direction, heading, changes in headings, etc. as extracted from image, sensor, satellite data, etc. In another embodiment, the system 100 can characterize pedestrian behaviors based on traffic light data (e.g., green or red, to detect illegal behaviors, such as running red-lights), e.g., collected from safety cameras, phone cameras, vehicle sensors, etc. In another embodiment, the system 100 can characterize pedestrian behaviors based on image data, such as inattentive people shown in a mirror, head-mounted devices, smart watches, infrastructure sensors (know the status of a traffic/walk light), etc. Alternatively or currently, the system 100 can get a pedestrian movement pattern based on probe data to match up with a given set of behaviors and determine as an inattentive pedestrian. In terms of jaywalking incidents, the system 100 can map-match the pedestrian probe trajectory to determine that the pedestrian crosses roads at locations other than cross-walks (“jaywalking”), thereby counting jaywalking incidents.

In another embodiment, the vehicles 101 are configured with various sensors (e.g., vehicle sensors 103) that can generate vehicle probe data. In terms of bus-catching incidents, the system 100 can compare the pedestrian probe trajectory against the bus probe trajectory (with or without map-matching) to determine that the pedestrian chased after the bus, thereby counting bus-catching incidents.

The probe points can be reported from the UE 115 and/or the vehicles 101 in real-time, in batches, continuously, or at any other frequency requested by the system 100 over, for instance, the communication network 118 for processing by the mapping platform 107. The probe points also can be map matched to specific road links stored in the geographic database 123. In one embodiment, the system 100 (e.g., via the mapping platform 107) can generate probe traces (e.g., pedestrian/vehicle paths or trajectories) from the probe points for an individual probe so that the probe traces represent a travel trajectory or vehicle path of the probe through the road network.

It is noted therefore that the above described sensor data and/or probe data may be transmitted via communication network 118 according to any known wireless communication protocols. For example, each UE 115, application 117, user, and/or vehicle 101 may be assigned a unique probe identifier (probe ID) for use in reporting or transmitting said probe data collected by the vehicles 101 and/or UEs 115. In one embodiment, each vehicle 101 and/or UE 115 is configured to report probe data as probe points, which are individual data records collected at a point in time that records telemetry data.

FIG. 2B is a diagram of a map user interface 221 depicting example partitions associated erratic pedestrian behaviors, according to example embodiment(s). By way of example, the jaywalking partition 111a is located next to a soccer field 223, and the bus chasing partition 111b is located in front of a train station 225. In these cases, the system 100 can determine a correlation between one type of erratic pedestrian behaviors and a location of feature(s) (e.g., a point of interest). In one embodiment, there are different types of erratic pedestrian behaviors. As noted above, erratic pedestrian behaviors are physical pedestrian behaviors that have a probability of impacting traffic in the travel network 109.

In one embodiment, a partition can be defined as a location/area with map feature(s) within a proximity of a point of interest, such as a road of a functional class and/or other map feature(s). For instance, US federal Highway Performance Monitoring System (HPMS) codes road functional class as Interstate (1), Other Freeways & Expressways (2), Other Principal Arterial (3), Minor Arterial (4), Major Collector (5), Minor Collector (6), Local (7), and/or other data item descriptions: Length Class A Curves (63), Length Class A Grade (72), Peak Capacity (95), Volume/Service Flow Ratio (96), etc.

By way of example, the system 100 can code jaywalking incident positions on a road link as from a link node of the road link and for a distance (e.g., offset) along the road link. As such, the jaywalking partition 111a can be coded as a road-link attribute/section along the road link between two offsets. In this case, the jaywalking partition 111a starts from a link node with an offset “0” and ends at a distance “a1” from the link node, such that its offsets can be recorded as an array (e.g., (0, a1)), enumeration, etc. For instance, the jaywalking partition 111a is located from a link node on a north section of the Kenndeyplein (e.g., LinkID_X-n, functional class: Local, Peak Capacity: medium, etc.) with a distance “0” and ends at a location from another link node on the Kenndeyplein for a distance “a1”. When the traffic is medium, the pedestrian(s) does not have to run fast to cross the road, thus the erratic pedestrian behavior impact is easier to mitigate by the system 100. As such, the jaywalking partition 111a can be coded as: LinkID_X-n, (0, a1), local, medium, etc.

As another example, the bus chasing partition 111b includes a right curbside, a bus-only lane, one adjacent bike lane, one adjacent vehicle lane, since the system 100 determines from the sensor data that pedestrians chased buses in these locations. For instance, the system 100 can simplify the partition by coding all the lanes and the curbside into one rectangular area with a distance “b1” from a beginning node and a distance “c1” from an end node on a south section of the Kenndeyplein plus a right margin Y from the road to respect the curbside. As such, the bus chasing partition 111b can be coded as: LinkID_X-s, (b1, c1), Y, local, medium, etc.

Such partition map attributes (e.g., LinkID_X-n, (0, a1), local, medium, etc.) is light-weighted (e.g., less than a kilobyte) and does not require as much resources to store, transmit, and map-match when compared to mapping based on polygons for geofences, area definitions, etc. By piggybacking on road links and nodes of a pre-defined map database, the partition map attribute has a compact data size compared with a geographic information system (GIS) polygon object that stores its geographic representation as a series of geographic coordinate sets enclosing a partition location/area. The compact data size of the partition map attribute takes less memory space to store and less communication bandwidth to transmit. In addition, since the partition map attribute is tired to a road link, a vehicle can directly map its currently location with respective to a current road link and determine whether the partition location, avoiding more complex functions to match the partition to road geometry which requires much more computation resources and processing time.

In addition to spatial parameters in the partition map attributes as discussed, FIG. 2B also depicts partitions temporal parameters, such as 24-hr, 10:00 pm to 2:30 am, etc., to be included in a partition map attribute. For example, the system 100 can determine a red-light-running partition 111c that lasts 24-hr covering an intersection 227 of the south section and an east section of the Kenndeyplein near the train station 235, where there are observations of around-the-clock pedestrians running via red-lights to catch trains. As such, the red-light-running partition 111c can be coded as: LinkID_X-s, (d1, e1), local, medium, etc.

As another example, the system 100 can determine a nightlife partition 111d that exists during 10:00 pm to 2:30 am every night near a bar 229, where there are observations of inattentive pedestrians walking around during 10:00 pm to 2:30 am. The partition map attributes of the partitions 111c, 111d can further include the respective temporal parameter. There are situations that partition map attributes with temporal parameters associated with a relatively big spatial parameter (e.g., beyond a road link), such as the whole downtown Washington D.C. is jammed with pedestrians during July 4^{th} firework. As such, a firework jaywalking partition can be coded as: DC downtown, 8:00-11:00 pm, 7/4/2021, etc.

In addition to the fixed POIs (e.g., the soccer field, the train station, the intersection, the bar, DC downtown, etc.) as discusses, the system 100 can code partition map attributes associated with dynamic/mobile POIs, such as buses (e.g., with pedestrians waiting in lines to get in buses), ice cream trucks (e.g., with pedestrians standing around to get ice cream), food trucks, vendor stands, etc. that can change locations. For example, the system 100 can code a partition map attribute of a food truck 231 based on its parking locations (e.g., GPS coordinates) and an operation schedule (e.g., 9:00-18:00, Monday to Friday at location A and 11:00-20:00 Saturday-Sunday at location B) as (A, 9:00-18:00 Mon.-Fri.), (B, 11:00-20:00 Sat.-Sun), local, medium, etc. As another example, the system 100 can code a partition map attribute of an ice cream truck 233 based on its trajectory (e.g., its probe data).

In other embodiment, the system 100 can include in a partition map attribute other contextual paraments that contribute to a type of erratic pedestrian behaviors, such as weather (e.g., pedestrians running via red-lights in heavy rain), presence of human accessory objects (e.g., balls/toys/animals as indicators of children/pedestrian, such as dog parks), population density, traffic, etc.

Once determining which partitions/areas are more risky due to the higher likelihood of pedestrian erratic behaviors, the system 100 can mitigate the risks for vehicles, vehicle users (e.g., drivers, passengers, etc.), etc. by public authorities via actions and/or recommendations. For instance, the vehicles and users can adapt actions for erratic partition(s).

FIG. 2C is a flowchart of a process 241 for applying partitions/correlations associated with erratic pedestrian behaviors, according to example embodiment(s). After partition(s) associated with erratic pedestrian behaviors are identified in Step 243 and correlation(s) of the partition(s) to map feature(s) are determined in Step 245 as discussed, the system 100 can generate vehicle operation instruction(s) for traditional vehicle(s) and/or autonomous vehicle(s), such as “avoid the bar area to save 15 min”, in Step 247, optimal POI operation hours for POIs in Step 249, recommended traffic management action(s) in Step 251, etc., thereby providing safety, predictability, road accessibility, better or no ETA impact, traffic, city planning, etc. in Step 253.

The system 100 can recognize certain situation(s) occurs, then instruct/recommend some mitigation actions that will improve the situations. In one embodiment, the system 100 can translate the erratic pedestrian behaviors/partitions into mitigation recommendations based on heuristics and/or machine learning. For example, the system 100 observed a lot of erratic pedestrian behavior incidents and accidents in a school zone, list mitigation actions/schemes of deploying police, vehicle slowing down, moving a transposition stop, etc. into a matrix (e.g., one-to-one, many-to-many, etc.), ranking the actions based on impacts/effectiveness, and present recommendations.

Regarding Step 247, on top of existing services (e.g., routing, search, parking, etc.), the system 100 can decide the most relevant action(s) for autonomous vehicle(s) to take based on the data related to areas where pedestrians show high deviation from standard behaviors, such as changing to the least risky lane when approaching a partition/area with more erratic pedestrian behaviors, considering safety, ETA impact, possible damages caused to vehicles and other elements. The system 100 can execute the action automatically or query for user confirmation.

By way of example, when determining a vehicle is approaching erratic partition(s), the system 100 can instruct the vehicle to react by changing its mode of operation (e.g., slowing down, stopping, reverting to manual control if currently in autonomous operating mode, taking an alternate route, making a U-turn, refusing the driving order for the user/destination, changing the vehicle type/attributes needed to perform the trip, proposing an alternative destination, proposing an alternative time to go the destination, etc.) or by changing driving rules (e.g., increased object avoidance, etc.), activating additional sensors, etc. In this way, the system 100 can automatically activate or trigger vehicle action(s) when a vehicle is expected to be within proximity of a spatial and/or temporal partition(s) associated with an erratic pedestrian behavior, or take such action(s) in response to a detected erratic pedestrian behavior. This approach, for instance, advantageously mitigate impacts of erratic pedestrian behaviors to, e.g., increase safety, improve traffic flow, etc.

In one embodiment, the system 100 or the autonomous vehicle can decide which action(s)/strategy to take in different situations depending on the likely impact(s) on ETA (e.g., related to speed reduction), damages risks for the vehicle, etc. In another embodiment, the system 100 or the autonomous vehicle can decide which action(s)/strategy to take in different situations depending on safety risks. For instance, when the safety risks are high, the partition/area should be avoided, regardless the impact(s) on ETA.

In another embodiment, the system 100 or the autonomous vehicle can ask the passenger(s) to make a decision, such as generating an audio output: “The vehicle will take the shortest route due to a higher risk related to pedestrians thereon, but this will lead to an increased ETA of 20 min. Is this choice acceptable?” In case the user does not accept the choice, the system 100 will have to handle the “risky” situation in the optimal way, such as applying mitigation action(s) when reaching the risky partition, or by asking the passenger to manually drive if possible.

In the case of autonomous modes of levels of operation, the system 100 can instruct the vehicles 101 to react to determined spatial and/or temporal partition(s) associated with erratic pedestrian behavior(s) 111 by actions such as automatically slow, take a different route, etc. Even in the case of completely manual driving (e.g., level 0), a vehicle 101 can automatically trigger sensors to provide greater situational awareness to improve safety for drivers. For example, infrared sensors can warn drivers of potential nearby humans or animals even when they may be obscured by vegetation or other obstacles (e.g., walls, roadside objects, etc.).

In one embodiment, the sensors 103 are controlled by sensor control modules 105a-105n (also collectively referred to as sensor control modules 105) of each of the vehicles 101 to perform the functions of the various embodiment described herein for spatial/temporal partition identification and partition/map feature correlation determination associated with erratic pedestrian behavior(s). In one embodiment, the vehicles 101 operate within a road or travel network 109 to detect one or more erratic pedestrian behaviors that can be aggregated into spatial/temporal partitions associated with erratic pedestrian behaviors. In one embodiment, the human 113 is equipped with a user equipment 115 (e.g., a mobile terminal, smartphone, etc.) executing an application 117 to facilitate communication over the communication network 118.

In one embodiment, a vehicle sensor 103 (e.g., a camera sensor, Lidar sensor, infrared sensor, radar sensor, etc.) can continuously operate to identify erratic pedestrian behavior(s) and/or relevant spatial/temporal partition(s) 111. For instance, a sensor 103 can be configured to operate with one set of operational parameters (e.g., sampling rate, field of view, resolution, etc.) to detect the partitions 111 of erratic pedestrian behaviors. For example, an infrared sensor can be configured to operate in either a passive mode (e.g., reading ambient heat signatures of the surrounding area) or in an active mode (e.g., illuminating the surrounding area with infrared waves to increase range, resolution, etc.). In this scenario, the passive configuration of the infrared sensor can perform the initial detection of an erratic pedestrian behavior incident, and then as an advanced sensor 105 for scanning of the presence of a human 113 that performs the erratic pedestrian behavior incident.

In another embodiment, the travel network 109 is configured with one or more infrastructure sensors 119 that can also be used to detect the erratic pedestrian behavior incidents within respective geographic coverage areas of the infrastructure sensors 119. By way of example, the infrastructure sensors 119 may be configured to use any sensing technology (e.g., visible light camera sensors, Bluetooth, infrared sensors, Lidar sensors, radar sensors, acoustic sensors, and the like) to detect the erratic pedestrian behavior incidents. In one embodiment, the infrastructure sensors may be used in combination with or in place of any of the pedestrian/vehicle sensors discussed with respect to the various embodiments described herein.

Once the spatial and temporal partitions where pedestrians show high deviation from standard behaviors are identified, the system 100 can use such information to decide the most relevant action(s) to take for city authorities or POIs owners to reduce the safety risks. Regarding Step 249, the system 100 can recommend action(s) to point of interest operators in order to improve safety by taking the relevant actions to reduce the risks associated to erratic pedestrian behaviors, such as optimal opening times of some specific POIs (e.g., opening and closing one hour earlier/later). In this context, optimal can mean the best compromise between usual operating hours and lowering the accident risks.

Regarding Step 251, the system 100 can recommend action(s) to city authorities in order to improve safety by taking the relevant actions to reduce the risks associated to erratic pedestrian behaviors, such as influencing the flow of people for specific areas and times, adapting the timing of public transport (e.g., buses, trains, etc.), making the departure timing more flexible, contextually tuning the way(s) and timing of the traffic lights, etc.

In case of running red light, the system 100 can recommend adding police, and in case of running green light, the system 100 can recommend lengthening the green light time (machine learning). In case of AVs waiting above a threshold time for people to illegally crossing the street, the system 100 can instruct AVs to start honking and inching forward like a human driver.

In one embodiment, the system 100 can provide to the city authorities a ranked list of recommendations that are likely to increase safety for pedestrians and passengers, without slowing down the vehicle traffic. In one embodiment, the system 100 can analyze the data related to erratic pedestrian behaviors and run various simulations for the situations described above. Based on the output of the simulations, the system 100 can provide a ranked list of recommendations that would be likely to increase safety for pedestrians and AV passengers, without slowing down the vehicle traffic.

In one embodiment, the system 100 can measure key performance indicators (KPIs) based on measurements of e.g., safety, traffic fluidity, etc. to evaluate the success of recommend actions (e.g., recommendation to close/open certain entrances of a transit station).

By analogy, the system 100 can apply the process of FIG. 2C to positive pedestrian behaviors (e.g., walking fast via green-lights, helping the visually-impaired cross walkways, etc.) that increase traffic safety with respect to a baseline, and use the positive partition(s) and relevant correlation(s) to a location (e.g., a POI) as inputs for enhance or increase positive impacts on safety, predictability, road accessibility, better or no ETA impact, traffic, city planning, etc.

Beside the vehicles 101, the system 100 can provide apply the process of FIG. 2C to other modes of transport, such as bicycles (e.g., micro mobility of partition(s) walking on bike lane(s) slowly thereby clogging the bike lane so to recommend the bicycle to take a different route). In addition, the system 100 can apply the process of FIG. 2C to other pedestrians, such as to avoid inattentive pedestrians, or to improve self-awareness of the pedestrians.

In one embodiment, the system 100 can set legal standards, POI-based behaviors, general/common behaviors, etc. as the baseline. In case in an area with a high baseline (e.g., a lot of erratic pedestrian behaviors thus higher safety/ETA risk), the system 100 can observe/set the baseline can be as above the legal standards, the POI-based behaviors, the general/common behaviors city-wise, per street segment, etc. For instance, the system 100 can set the base line at least occurring 85% of the time. In addition, the system 100 can take delta behaviors derived from propagation of error into account, such as discounting the delta behaviors. Such higher baseline can be permanent, seasonal event-trigger (e.g., black Friday sales), etc. In this case, the system 100 can recommend the vehicles 101 not to go to the sales location(s) on black Friday.

In one embodiment, the vehicles 101 also have connectivity to a mapping platform 107 over the communication network 118. In one embodiment, the mapping platform 107 performs functions related to generating mapping data (e.g., location-based records) to record detected erratic pedestrian behavior incidents and aggregate/correlate them to geographic areas described in a geographic database 123. In another embodiment, the mapping platform 107 provides location-based records indicating geographic areas in which spatial and/or temporal partition(s) associated with erratic pedestrian behavior(s) have been detected in geographic areas (e.g., as determined by a positioning system such as satellite-based positioning system 124). In one embodiment, the vehicles 101 can be detected to enter the areas by, for instance, geofencing around the location or areas specified in the location-based record, applying a distance threshold from the location or areas specified in the location-based record, and/or any other means for determining a vehicle 101's proximity to the location or area specified in the location-based record. For example, to create a geofence, the mapping platform 107 may specify a virtual perimeter around the location or areas of interest.

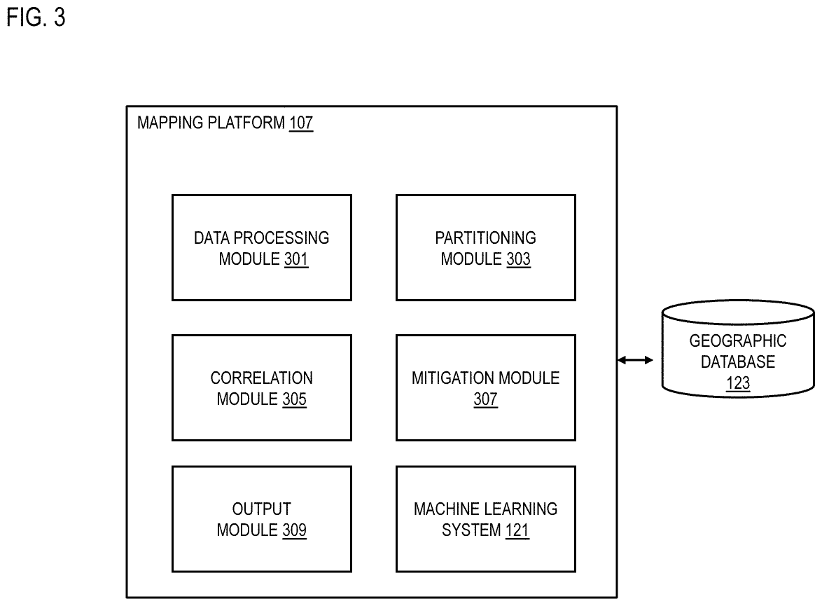

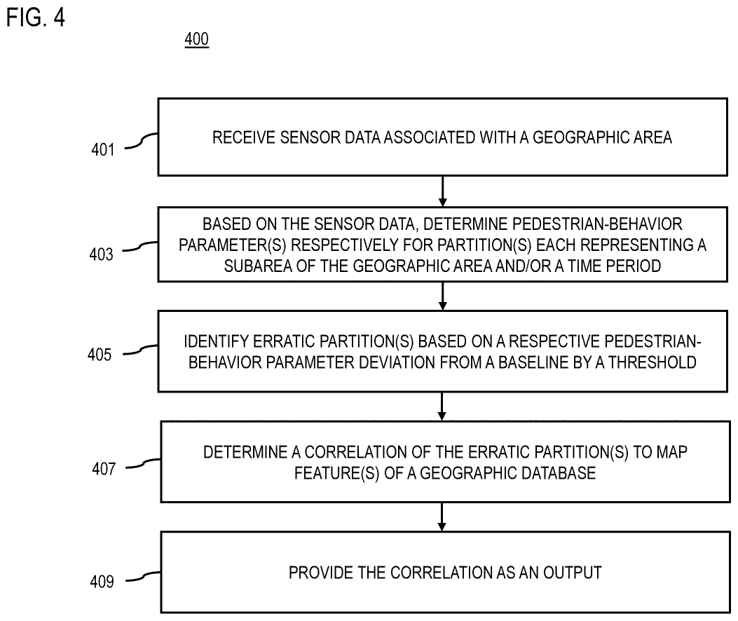

FIG. 3 is a diagram of the components of the mapping platform 107, according to one or more example embodiments. In one embodiment, the mapping platform 107 includes one or more components for minimizing potential vehicle accident impact(s) based on accident/road link correlation and/or contextual data according to the various embodiments described herein. As shown in FIG. 3, the mapping platform 107 includes a data processing module 301, a partition module 303, a correlation module 305, a mitigation module 307, an output module 309, and the machine learning system 121 and has connectivity to the geographic database 123. The above presented modules and components of the mapping platform 107 can be implemented in hardware, firmware, software, or a combination thereof. The above presented modules and components of the mapping platform 107 can be implemented in hardware, firmware, software, or a combination thereof. It is contemplated that the functions of these components may be combined or performed by other components of equivalent functionality. Though depicted as a separate entity in FIG. 1, it is contemplated that the mapping platform 107 may be implemented as a module of any of the components of the system 100 (e.g., a component of the vehicle 101 and/or UE 115). In another embodiment, the mapping platform 107 and/or one or more of the modules 301-309 may be implemented as a cloud-based service, local service, native application, or combination thereof. The functions of the mapping platform 107, the machine learning system 121, and/or the modules 301-309 are discussed with respect to FIGS. 4-7 below. The process 400 can be implemented by a vehicle 101 (e.g., matching partitions in real time at scene), or a system server (edge or cloud) to provide a live map, etc.

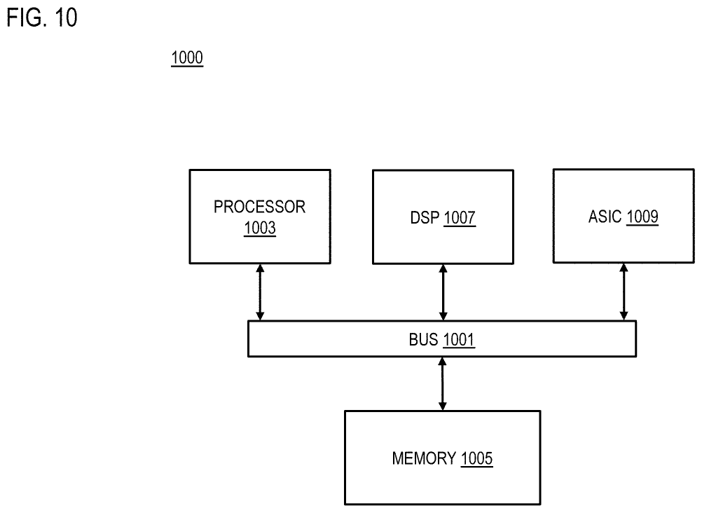

FIG. 4 is a flowchart of a process for minimizing potential vehicle accident impact(s) based on accident/road link correlation and/or contextual data, according to one or more example embodiments. In various embodiments, the mapping platform 107, the machine learning system 121, and/or any of the modules 301-309 may perform one or more portions of the process 400 and may be implemented in, for instance, a chip set including a processor and a memory as shown in FIG. 10. As such, the mapping platform 107 and/or the modules 301-309 can provide means for accomplishing various parts of the process 400, as well as means for accomplishing embodiments of other processes described herein in conjunction with other components of the system 100. The steps of the process 400 can be performed by any feasible entity, such as the mapping platform 107, the modules 301-309, the machine learning system 121, etc. Although the process 400 is illustrated and described as a sequence of steps, it is contemplated that various embodiments of the process 400 may be performed in any order or combination and need not include all the illustrated steps.

In one embodiment, for example in step 401, the data processing module 301 can receive, from one or more sensors (e.g., the sensors 103 of the vehicles 101, the infrastructure sensors 119, etc.), sensor data associated with a geographic area. As mentioned, the sensor data can include probe data indicating a speed, a heading, a heading change, or a combination thereof as the one or more features of the pedestrian of the behavior.

In one embodiment, in step 403, the partitioning module 303, based on the sensor data, can determine one or more pedestrian-behavior parameters respectively for one or more partitions. For instance, a given pedestrian-behavior parameter (e.g., crossing position/speed/traffic on a road link) can correspond to a digital measurement or representation of a particular behavior (e.g., jaywalking) by one or more pedestrians. Other pedestrian-behavior types, such as bus/train catching, red-light running, inattentive due to nightlife events, distracted by user devices, distracted by POIs, etc. have different pedestrian-behavior parameters. Each respective partition (e.g., the jaywalking partition 111a in FIG. 2B) of the one or more partitions represents a respective subarea of the geographic area (e.g., a rectangular box marked on a road link in FIG. 2B), a respective time period (e.g., during soccer practice time period(s)), or a combination thereof.

In one embodiment, in step 405, the partitioning module 303 can identify at least one erratic partition (e.g., the jaywalking partition 111a in FIG. 2B) from the one or more partitions based on determining that a respective pedestrian-behavior parameter (e.g., crossing position/speed/traffic on a road link) associated with the at least one erratic partition deviates from a baseline pedestrian-behavior parameter by at least a threshold extent (e.g., running speed over 2 mph, traffic over medium, etc.). For instance, the sensor data can be collected from a first time epoch (e.g., during the soccer practice time period(s)), and the baseline pedestrian behavior can be determined from other sensor data collected from a second time epoch that is different from the first time epoch (e.g., outside of the soccer practice time period(s)).

In one embodiment, in step 407, the correlation module 305 can determine a correlation of the at least one erratic partition (e.g., the jaywalking partition 111a in FIG. 2B) to at least one map feature (e.g., the soccer field 223 in FIG. 2B) of a geographic database (e.g., the geographic database 123). In one embodiment, the correlation can be determined further based on a population density (e.g., near the road link, the partition 111a, a corresponding map tile, zip code, community, town, city, etc.), an origin/destination (O/D) matrix of one or more pedestrian paths (e.g., pedestrian O/D trajectories near the road link, the partition 111a, the corresponding map tile, zip code, community, town, city, etc.) represented in the sensor data, or a combination thereof. The pedestrian O/D trajectories can be aggregated into the jaywalking partition 111a in FIG. 2B.

In another embodiment, the correlation can be determined based on at least one isoline generated from a location of the at least one map feature (e.g., the soccer field 223 in FIG. 2B), based on a starting or end point of a pedestrian path indicated in the sensor data, or a combination thereof. For instance, the correlation module 305 can use an isoline routing algorithm to request a polyline that connects the end points of all pedestrian routes leaving from one defined center (e.g., of the soccer field 223 in FIG. 2B) with either a specified length (e.g., 100 feet) or a specified travel time (e.g., 3 minutes). The correlation module 305 can calculate time-based isolines, specify time as a range type and considering various transport modes (e.g., running, walking, etc.). Range can be specified in seconds, minutes, hours, days, months, years, or other time segments. The time-based isolines can then be used to determine the range of the jaywalking partition 111a.

In one embodiment, the partitioning module 303 can classify the pedestrian behavior into a behavior type, and the deviation of the pedestrian behavior can be determined by the correlation module 305 with respect to the behavior type. By way of example, the behavior type can include, at least in part, a running behavior, a falling behavior, an inattention behavior, an illegal pedestrian behavior, or a combination thereof.

In one embodiment, the mitigation module 307 can determine one or more instructions for operating an autonomous vehicle based on the at least one erratic partition (e.g., the jaywalking partition 111a in FIG. 2B), the correlation of the at least one erratic partition to at least one map feature (e.g., the soccer field 223 in FIG. 2B), or a combination thereof. By way of example, the one or more instructions can include at least one of: (1) reducing speed within a threshold proximity of the at least one map feature (e.g., the soccer field 223 in FIG. 2B), the subarea associated with the at least one erratic partition (e.g., the jaywalking partition 111a in FIG. 2B), or a combination thereof (2) re-routing to avoid the at least one map feature (e.g., the soccer field 223 in FIG. 2B), the subarea associated with the at least one erratic partition (e.g., the jaywalking partition 111a in FIG. 2B), or a combination thereof; (3) changing a lane to avoid pedestrian traffic within the threshold proximity of the at least one map feature (e.g., the soccer field 223 in FIG. 2B), the subarea associated with the at least one erratic partition (e.g., the jaywalking partition 111a in FIG. 2B), or a combination thereof; (4) returning to a starting point (e.g., back to home); (5) refusing to drive within the threshold proximity of the at least one map feature (e.g., the soccer field 223 in FIG. 2B), the subarea associated with the at least one erratic partition (e.g., the jaywalking partition 111a in FIG. 2B), or a combination thereof; (6) changing a vehicle type (e.g., a bicycle) to perform a trip within the threshold proximity of the at least one map feature (e.g., the soccer field 223 in FIG. 2B), the subarea associated with the at least one erratic partition (e.g., the jaywalking partition 111a in FIG. 2B), or a combination thereof; (7) recommending an alternative destination (e.g., a gym); or (8) recommending an alternative time (e.g., outside of the soccer practice time period(s)) to perform the trip within the threshold proximity of the at least one map feature (e.g., the soccer field 223 in FIG. 2B), the subarea associated with the at least one erratic partition (e.g., the jaywalking partition 111a in FIG. 2B), or a combination thereof.

As other example instructions for operating an autonomous vehicle, changing lane when the mitigation module 307 determines people are more likely to randomly cross a given lane, typically the one closer to the sidewalk. In the case of roads with more than one lane, the mitigation module 307 can decide to use the least risky lane when possible/applicable. The mitigation module 307 can decide that the risks/costs are too high at a given point of the journey and that it makes more sense to safely drive the user back to the starting point. In this case, the mitigation module 307 can ask the user what for preferences. The mitigation module 307 can consider all related consequences related to the risks associated to the ride When to compute an original route, and then the AV or the mitigation module 307 can decide to refuse the driving order for such risks. The mitigation module 307 can also decide that the user needs a vehicle with specific attributes and that the originally selected AV is suitable. As such, the mitigation module 307 can either decide to send another AV or the user can start the journey with the original AV and then switch later in the journey. The mitigation module 307 might decide that it is too risky to go to a specific area or destination due to the hazard related to pedestrian behaviors. In such cases, the mitigation module 307 can propose an alternate destination, e.g., a bar or restaurant in a quieter area or not having to drive through a partition/area with high risk. The mitigation module 307 might also suggest the user to go to this destination at another time or day after the risk assessment.

In another embodiment, the mitigation module 307 can incorporate into a routing algorithm such risk information (e.g., risk associated to erratic pedestrian behaviors) as routing parameter(s) and use the routing algorithm when setting penalties to all the routable links.

In another embodiment, the map feature can be a point of interest (e.g., the bar 229 in FIG. 2B), and the mitigation module 307 can compute an optimal time for opening the point of interest (e.g., opening the bar after 11:00 pm when vehicle traffic is light) based on determining a partition (e.g., the nightlife partition 111d that exists during 10:00 pm to 2:30 am every night) corresponding to a respective time period during which the deviation of the respective pedestrian-behavior parameter from the baseline pedestrian-behavior parameter is associated with a target pedestrian safety value.

In other embodiments, the mitigation module 307 can (1) determine one or more recommended traffic management actions based on the at least one erratic partition (e.g., the bus-catching partition 111b in FIG. 2B), the correlation of the at least one erratic partition to at least one map feature (e.g., the train station 225 in FIG. 2B), or a combination thereof, and (2) present the one or more recommended traffic management actions in a user interface of a device. For instance, the one or more recommended traffic management actions can include at least one of: (1) influencing pedestrian traffic flow within a threshold proximity of the at least one map feature (e.g., the train station 225 in FIG. 2B), the subarea associated with the at least one erratic partition (e.g., the bus-catching partition 111b in FIG. 2B), or a combination thereof; (2) adapting a public transport schedule (e.g., bus schedule(s), train schedule(s), etc.) within the threshold proximity of the at least one map feature (e.g., the train station 225 in FIG. 2B), the subarea associated with the at least one erratic partition (e.g., the bus-catching partition 111b in FIG. 2B), or a combination thereof; (3) adapting a traffic light timing within a threshold proximity of the at least one map feature (e.g., the train station 225 in FIG. 2B), the subarea associated with the at least one erratic partition (e.g., the bus-catching partition 111b in FIG. 2B), or a combination thereof; (4) placing police within a threshold proximity of the at least one map feature (e.g., the train station 225 in FIG. 2B), the subarea associated with the at least one erratic partition (e.g., the bus-catching partition 111b in FIG. 2B), or a combination thereof; (5) creating pedestrian infrastructure (e.g., overpasses, underpasses, etc.) within a threshold proximity of the at least one map feature (e.g., the train station 225 in FIG. 2B), the subarea associated with the at least one erratic partition (e.g., the bus-catching partition 111b in FIG. 2B), or a combination thereof; or (6) providing a ranked list of the one or more recommended traffic management actions based on a pedestrian safety parameter (e.g., crossing position/speed/traffic on a road link).

As other example recommended traffic management actions, the mitigation module 307 can recommend action(s) for influencing the flow of people, e.g., by closing some public transport entrance(s)/exit(s), closing a road/sidewalk, creating new ways for people to go from some areas to others, etc. The system 100 can recommend action(s) for influencing vehicle traffic, such as redirecting traffic at given times, lowering car traffic, traffic light adaptive management, etc.

The mitigation module 307 can recommend action(s) for adapting the timing of public transport or making the departure time more flexible, such as giving more time between public transport connections to avoid that people need to run to catch the t public transport, aligning the public transport departing time with the one of the nearby traffic lights, etc. The mitigation module 307 can learn (via machine learning, artificial intelligence, etc.) which specific bus lines/timing causes people behaves erratically (e.g., bus #101 of every hour).

The mitigation module 307 can recommend action(s) to increase the frequency of public transport, such as increasing the frequency of buses to get intoxicated people home faster or to lower their frequency to lower accident risks. The mitigation module 307 can recommend action(s) to strategically place police forces near the areas identified as “more risky” to reduce the risk of unpredictable pedestrian behaviors. The mitigation module 307 can recommend action(s) to contextually tuning the ways and timing of the traffic lights. For instance, at some specific locations and times, traffic lights can be longer for pedestrians to lower the risks of people running to catch a bus/train.

The mitigation module 307 can recommend action(s) to create environmental alternatives (e.g., tunnels, larger pathways, etc.), such as new infrastructure planned to prevent accidents, new street features, new crosswalks, etc. The mitigation module 307 can recommend action(s) to set AV attribute recommendations for going through such partition/area, such as AV with capability A, B, C to be granted access to those “risky’ areas at those given times. The mitigation module 307 can recommend action(s) to avoid crowd gathering above some threshold levels in a specific area based on population density, to change AV attributes in the partition/area, etc., to mitigate risks associated with erratic pedestrian behaviors.

In one embodiment, the mitigation module 307 can analyze the data related to erratic pedestrian behaviors and run various simulations for the situations described above. Based on the output of the simulations, the mitigation module 307 can provide a ranked list of recommendations that would be likely to increase safety for pedestrians and AV passengers, without slowing down the vehicle traffic.

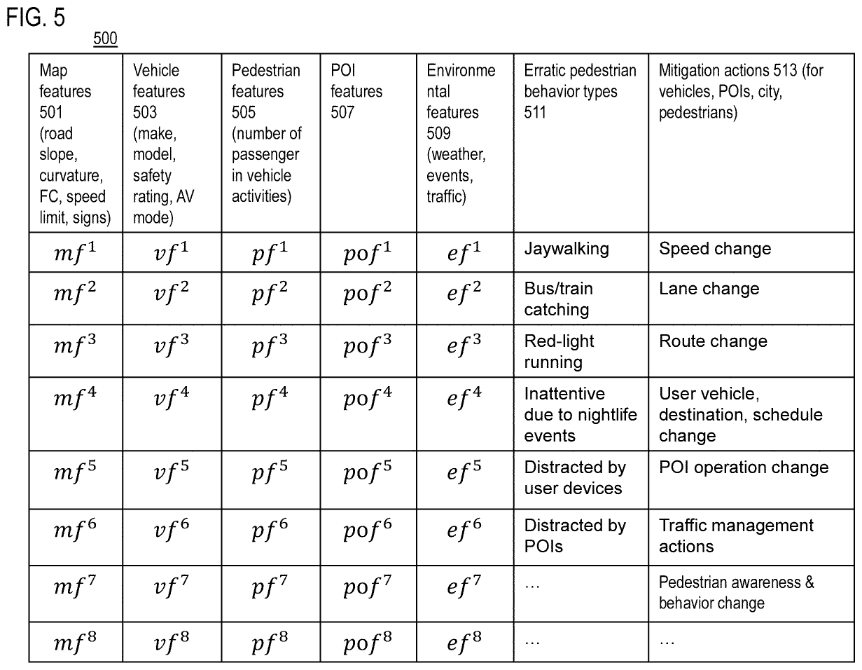

In one embodiment, the one or more features associated with the pedestrian behavior can be input to a trained machine learning model to identify the at least one erratic partition, the correlation, or a combination thereof. FIG. 5 is a diagram of an example machine learning data matrix, according to one or more example embodiments. In one embodiment, the matrix/table 500 can further include map feature(s) 501 (e.g., road link slope, curvature, FC, speed limit, signs, etc.), vehicle feature(s) 503 (e.g., make, model, characteristics, capabilities-speed range, safety rating, working belts, working airbags, AV/manual mode, etc.), pedestrian features 505 (e.g., ages, medical records, weight, height, pre-existing conditions, a number of nearby pedestrians, activities, destinations, etc.), POI features 507 (e.g., restaurants, hotels, campsites, gas stations, supermarkets, banks, hospitals, museum, etc.), environment features 509 (e.g., visibility, weather, events, traffic, traffic light status, construction status, etc.), etc., in addition to erratic pedestrian behavior types 511. For instance, these features 501-511 can be derived from map data, sensor data, context data of the vehicle 101, pedestrians, environment, etc. as discussed. In the matrix/table 500, jaywalking, bus/train catching, red-light running, inattentive due to nightlife events, distracted by user devices, distracted by POIs, etc. are listed as example erratic pedestrian behavior types 511.

By way of example, the matrix/table 500 can list relationships among features and training data. For instance, notation [symbol] mf [symbol] \hat{ }i can indicate the ith set of map features, [symbol] vf [symbol] \hat{ }i can indicate the ith set of vehicle features, [symbol] pf [symbol] \hat{ }i can indicate the ith set of pedestrian features, [symbol] pof [symbol] \hat{ }i can indicate the ith set of POI features, [symbol] ef [symbol] \hat{ }i can indicate the ith set of environmental features, etc.

In one embodiment, the training data can include ground truth data taken from historical pedestrian behaviors and impact data. For instance, in a data mining process, features are mapped to ground truth behavior and impact data to form a training instance. A plurality of training instances can form the training data for a behavior and impact machine learning model using one or more machine learning algorithms, such as random forest, decision trees, etc. For instance, the training data can be split into a training set and a test set, e.g., at a ratio of 50%:30%. After evaluating several machine learning models based on the training set and the test set, the machine learning model that produces the highest classification accuracy in training and testing can be used as the behavior and impact machine learning model. In addition, feature selection techniques, such as chi-squared statistic, information gain, gini index, etc., can be used to determine the highest ranked features from the set based on the feature's contribution to classification effectiveness.

In other embodiments, ground truth behavior and impact data can be more specialized than what is prescribed in the matrix/table 500. For instance, the ground truth could be jaywalking behaviors that caused accidents, traffic jams, etc. In the absence of one or more sets of the features 501-509, the model can still make a prediction using the available features.

In one embodiment, the behavior and impact machine learning model can learn from one or more feedback loops. For example, when an accident index (e.g., a dynamic risk assessment value of the potential negative impact and/or the potential accident on a current road link) caused by jaywalking is computed/estimated to be very high yet no pedestrian gets injured any more (e.g., due to road constructions, implementation of mitigation actions 513, etc.), the behavior and impact machine learning model can learn from the feedback data, via analyzing and reflecting how the high index was generated. The behavior and impact machine learning model can learn the cause(s), for example, based on the map feature(s), the pedestrian wearing a reflective vest, etc., and include new features into the model based on this learning. Alternatively, the behavior and impact machine learning model can blacklist the road links where the deviation is high but no accident occurs.

By analogy, a mitigation action learning model that can determine the mitigation actions 513 to be taken by vehicles, POIs, city, pedestrians, etc. prior to or during the road link, based on features 501-509, erratic pedestrian behavior types 511, etc. can be used for training in a similar way. In one embodiment, the machine learning system 121 selects respective features 501-511 such as road topology, vehicle model, vehicle operation settings, traffic patterns, erratic pedestrian behavior types, etc., to determine the optimal mitigation action(s) to be taken by the vehicles, POIs, city, pedestrians, etc. for different scenarios on different road links. As a result, an additional column can be added in the matrix/table 500 to include mitigation actions 513 (for vehicles, POIs, city, pedestrians, etc.). By way of example, the mitigation actions 513 can include speed change, lane change, route change, user vehicle/destination/schedule change, POI operation change, traffic management actions pedestrian awareness, pedestrian behavior change, etc.

In other embodiments, the machine learning system 121 can train the behavior and impact machine learning model and/or the mitigation action machine learning model to select or assign respective weights, correlations, relationships, etc. among the features 501-513, to determine optimal action(s) to take for different behavior and impact scenarios on different road links. In one instance, the machine learning system 121 can continuously provide and/or update the machine learning models (e.g., a support vector machine (SVM), neural network, decision tree, etc.) of the machine learning system 121 during training using, for instance, supervised deep convolution networks or equivalents. In other words, the machine learning system 121 trains the machine learning models using the respective weights of the features to most efficiently select optimal action(s) to take for different behavior and impact scenarios on different road links.

In another embodiment, the machine learning system 121 of the mapping platform 107 includes a neural network or other machine learning system(s) to update enhanced features on road links. In one embodiment, the neural network of the machine learning system 121 is a traditional convolutional neural network which consists of multiple layers of collections of one or more neurons (which are configured to process a portion of an input data). In one embodiment, the machine learning system 121 also has connectivity or access over the communication network 118 to the geographic database 123 that can each store map data, the feature data, the outcome data, etc.

In one embodiment, the machine learning system 121 can improve the machine learning models using feedback loops based on, for example, vehicle behavior data and/or feedback data (e.g., from passengers). In one embodiment, the machine learning system 121 can improve the machine learning models using the vehicle behavior data and/or feedback data as training data. For example, the machine learning system 121 can analyze correctly identified accident/impact data and/or action data, missed accident/impact data and/or action data, etc. to determine the performance of the machine learning models.

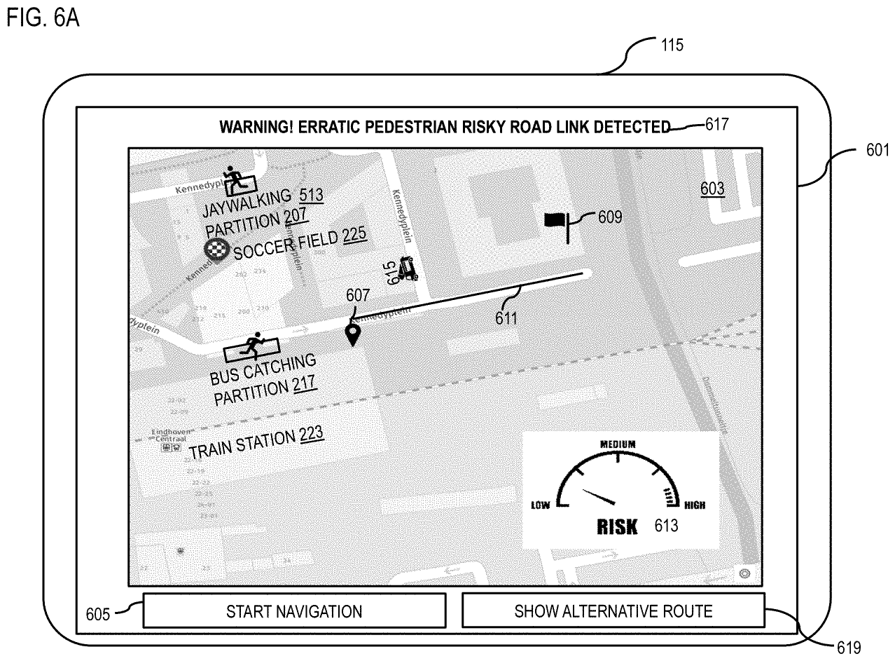

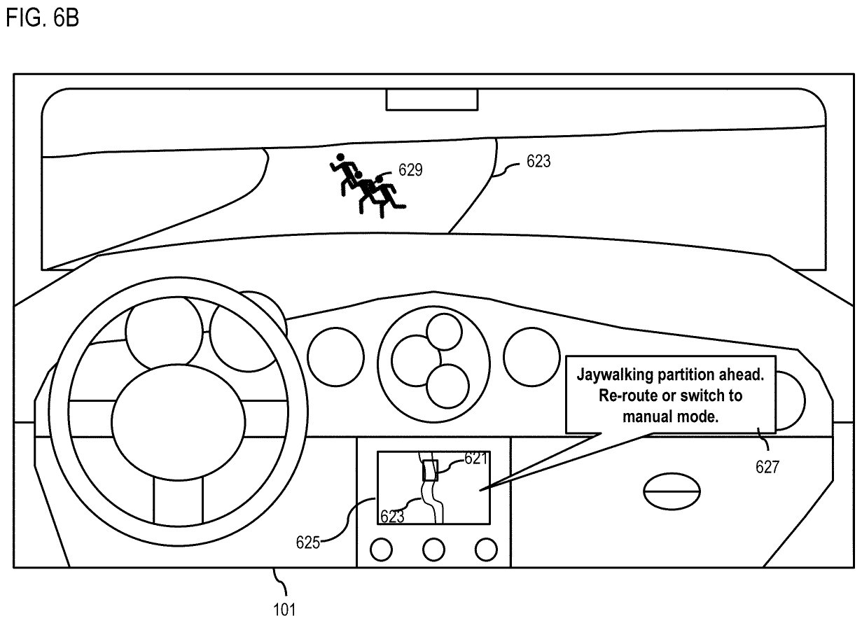

In one embodiment, in step 409, the output module 309 can provide the correlation as an output. By way of example, the output module 309 can generate a mapping user interface that presents a representation of the at least one erratic partition, the correlation of the at least one erratic partition to at least one map feature, or a combination thereof. The output module 309 can generate a map view of a city and highlight partitions, such as at every 5-min window. A user can click for partitions with high deviations, then get recommendation, behavior type(s), mitigation actions, etc. By way of example, FIGS. 6A-6B are diagrams illustrating example vehicle user interfaces for displaying and/or mitigating partition(s) associated with erratic pedestrian behaviors, according to example embodiment(s).

FIG. 6A is a diagram of an example user interface (UI) 601 (e.g., of a navigation application) capable of displaying erratic partition(s) during navigation, according to example embodiment(s). In this example, the UI 601 shown is generated for a UE 115 (e.g., a mobile device, an embedded navigation system of the vehicle 101, a server of a vehicle fleet operator, a server of a vehicle insurer, etc.) that includes a map 603, an input 605 of “Start Navigation” between an origin 607 and a destination 609 along a route 611. The UI 601 also shows a safety risk gauge 613 associated with erratic pedestrian behaviors that monitors a real-time risk assessment value of a current road, which appears to be low and acceptable.

However, when determining a coming risky road link 615 (e.g., an ice cream truck), the system 100 can show an alert 617: “Warning! Erratic Pedestrian Risky Road Link Detected.” In response to an input 619 of “Show Alternative Route,” the UI 601 can present an alternative route (not shown).

FIG. 6B is a diagram illustrating a vehicle user interface for mitigating partition(s) associated with erratic pedestrian behaviors, according to example embodiment(s). As shown, a vehicle 101 is supported by the system 100 that is operated continuously to recommend action(s) to mitigate partitions associated with erratic pedestrian behaviors 111. In this example, a jaywalking partition 621 is determined on a road 623 shown in a user interface 625. Accordingly, the system 100 automatically presents a message 627: “Jaywalking partition ahead. Re-route or switch to manual mode.” At the same time, the vehicle 101 can presents a camera feed of captured street objects (e.g., jaywalking pedestrians 629) in the UI 625.

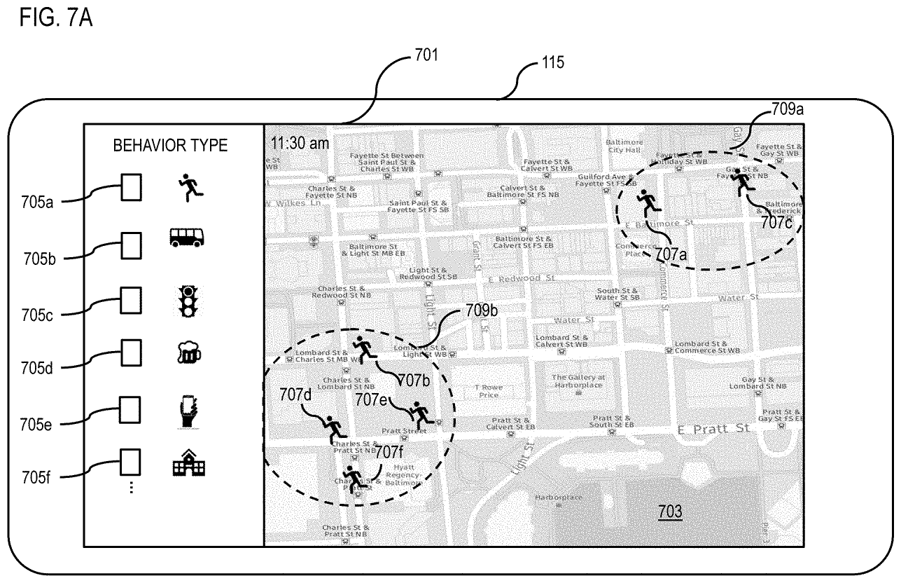

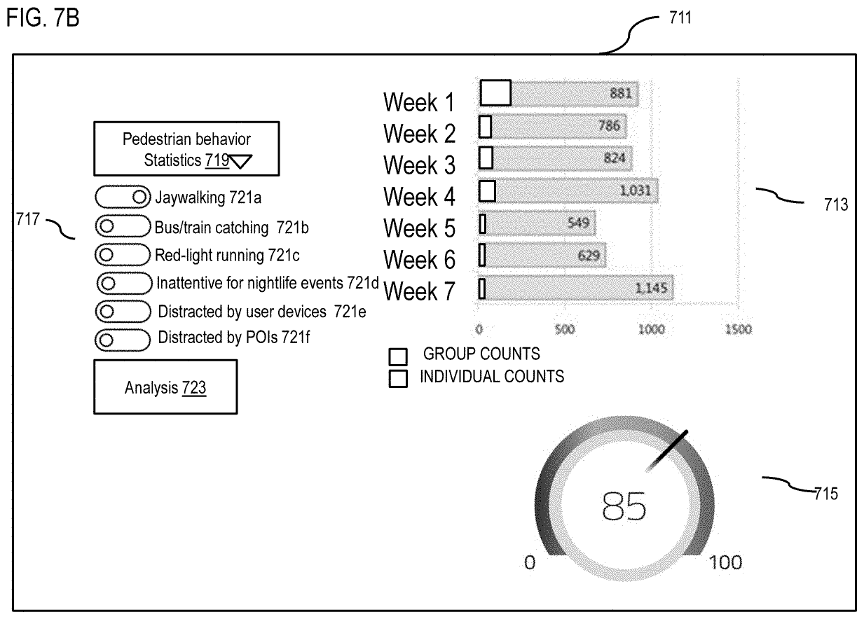

FIGS. 7A-7B are diagrams illustrating example user interfaces for displaying and/or mitigating partition(s) associated with erratic pedestrian behaviors for users outsides of vehicles, according to example embodiment(s). Referring to FIG. 7A, in one embodiment, the system 100 can generate a user interface (UI) 701 (e.g., the mapping application 117) for a UE 115 (e.g., a mobile device, a client terminal, a server of a POI operator, a server of a city authority, etc.) that can allow a user to see partitions associated with erratic pedestrian behaviors 111 currently and/or over time (e.g., an hour, a day, a week, a month, a year, etc.) in an area, where static and/or dynamic partition data is available as digital map data, to be presented via a map 703 upon selection of one or more partition types. For instance, the partition types in FIG. 7A includes jaywalking 705a, bus/train catching 705b, red-light running 705c, inattentive due to nightlife events 705d, distracted by user devices 705e, distracted by POIs 705f, etc. In FIG. 7A, for example, in response to a user selection of the jaywalking 705a at 11:30 am, and the system 100 can determine and present in the map 703 six jaywalking partitions 707a-707f that make into two clusters 709a, 709b. For instance, the system 100 can recommend the city authority to strategically place police forces into two clusters 709a, 709b to reduce jaywalking behaviors.

FIG. 7B is a diagram of a user interface associated with erratic pedestrian behavior statistics, according to example embodiment(s). In this example, the UI 711 shown may be generated for the UE 115 that depicts a bar chart 713 and a risky pedestrian behavior scale 715. For instance, the bar chart 713 shows weekly group and individual erratic pedestrian behavior counts per an area of interest (e.g., city, town, zone, community, district, zip code, map tile, partition, etc.), while the risky pedestrian behavior scale 715 shows a probability (e.g., an average) that the erratic pedestrian behavior count exceeds a baseline value.

The UI 711 further shows a display setting panel 717 that includes a setting dropdown menu 719, a plurality of pedestrian behavior statistics switches 721, and an input 723 of “Analysis.” By way of example, the statistics switches 721 included jaywalking 721a, bus/train catching 721b, red-light running 721c, inattentive due to nightlife events 721d, distracted by user devices 721e, distracted by POIs 721f, etc.

By way of example, the jaywalking 721a is switched on by a user (e.g., a pedestrian, a passenger, a POI operator, a city planner, etc. with different levels of data access based on credentials), and the user further selects the input 723 of “Analysis”. The user can be a human and/or artificial intelligence. As a result, the system 100 analyzes the weekly group and individual erratic pedestrian behavior counts using the above-discussed embodiments, calculates the group or individual erratic behavior score as 85, and displays accordingly. Such behavior analysis can help individual pedestrian, POI owner, and/or city planner to understand the situations and adapt mitigation action(s) recommended by the system 100.

The above-discussed embodiments can be applied to recommend actions to mitigate impacts of erratic pedestrian behaviors, thereby improving traffic safety, predictability, Acceptability of any road links (e.g., motorways, walkways, bicycle paths, train tracks, airplane runways, etc.).

In one embodiment, a vehicle 101 (e.g., an autonomous or highly assisted driving vehicle) is able to recognize (e.g., by object recognition of captured images or videos from a camera sensor) and distinguish between the two types of erratic pedestrian behaviors 111. The vehicle 101 can then react differently depending on the types.

In one embodiment, the vehicles 101 are autonomous vehicles or highly assisted driving vehicles that can sense their environments and navigate within a travel network without driver or occupant input. It is contemplated the vehicle 101 may be any type of transportation wherein a driver is in control of the vehicle's operation (e.g., an airplane, a drone, a train, a ferry, etc.). In one embodiment, the vehicle sensors 103 (e.g., camera sensors, light sensors, LiDAR sensors, radar, infrared sensors, thermal sensors, and the like) acquire map data and/or sensor data during operation of the vehicle 101 within the travel network for routing, historical trajectory data collection, and/or destination prediction.

In one embodiment, one or more user equipment (UE) 115 can be associated with the vehicles 101 (e.g., an embedded navigation system) a person or thing traveling within the travel network. By way of example, the UEs 115 can be any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, fitness device, television receiver, radio broadcast receiver, electronic book device, game device, devices associated with one or more vehicles or any combination thereof, including the accessories and peripherals of these devices, or any combination thereof. It is also contemplated that the UEs 115 can support any type of interface to the user (such as “wearable” circuitry, etc.). In one embodiment, the vehicles 101 may have cellular or wireless fidelity (Wi-Fi) connection either through the inbuilt communication equipment or from the UEs 115 associated with the vehicles 101. Also, the UEs 115 may be configured to access the communication network 118 by way of any known or still developing communication protocols.

In one embodiment, the UEs 115 include a user interface element configured to receive a user input (e.g., a knob, a joystick, a rollerball or trackball-based interface, a touch screen, etc.). In one embodiment, the user interface element could also include a pressure sensor on a screen or a window (e.g., a windshield of a vehicle 101, a heads-up display, etc.), an interface element that enables gestures/touch interaction by a user, an interface element that enables voice commands by a user, or a combination thereof. In one embodiment, the UEs 115 may be configured with various sensors for collecting passenger sensor data and/or context data during operation of the vehicle 101 along one or more roads within the travel network. By way of example, sensors of the UE 115 can be any type of sensor that can detect a passenger's gaze, heartrate, sweat rate or perspiration level, eye movement, body movement, or combination thereof, in order to determine a passenger context or a response to output data. In one embodiment, the UEs 115 may be installed with various applications 117 to support the system 100.

In one embodiment, the mapping platform 107 has connectivity over the communication network 118 to the services platform 125 that provides the services 127. By way of example, the services 127 may also be other third-party services and include mapping services, navigation services, travel planning services, notification services, social networking services, content (e.g., audio, video, images, etc.) provisioning services, application services, storage services, contextual information determination services, location-based services, information-based services (e.g., weather, news, etc.), etc.

In one embodiment, the content providers 129 may provide content or data (e.g., including geographic data, output data, historical trajectory data, etc.). The content provided may be any type of content, such as map content, output data, audio content, video content, image content, etc. In one embodiment, the content providers 129 may also store content associated with the weather event/road link correlation data, the geographic database 123, mapping platform 107, services platform 125, services 127, and/or vehicles 101. In another embodiment, the content providers 129 may manage access to a central repository of data, and offer a consistent, standard interface to data, such as a repository of weather event/road link correlation data and/or the geographic database 123.

By way of example, as previously stated the vehicle sensors 103 may be any type of sensor. In certain embodiments, the vehicle sensors 103 may include, for example, a global positioning sensor for gathering location data, a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data (e.g., for detecting objects proximate to the vehicle 101), an audio recorder for gathering audio data (e.g., detecting nearby humans or animals via acoustic signatures such as voices or animal noises), velocity sensors, and the like. In another embodiment, the vehicle sensors 103 may include sensors (such as LiDAR, Radar, Ultrasonic, Infrared, cameras (e.g., for visual ranging), etc. mounted along a perimeter of the vehicle 101) to detect the relative distance of the vehicle 101 from lanes or roadways, the presence of other vehicles, pedestrians, animals, traffic lights, road features (e.g., curves) and any other objects, or a combination thereof. In one scenario, the vehicle sensors 103 may detect weather data, traffic information, or a combination thereof. In one example embodiment, the vehicles 101 may include GPS receivers to obtain geographic coordinates from satellites 131 for determining current location and time. Further, the location can be determined by a triangulation system such as A-GPS, Cell of Origin, or other location extrapolation technologies when cellular or network signals are available. In another example embodiment, the one or more vehicle sensors 103 may provide in-vehicle navigation services.

The communication network 118 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, 5G networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the mapping platform 107 may be a platform with multiple interconnected components. By way of example, the mapping platform 107 may include multiple servers, intelligent networking devices, computing devices, components, and corresponding software for determining upcoming vehicle events for one or more locations based, at least in part, on signage information. In addition, it is noted that the mapping platform 107 may be a separate entity of the system 100, a part of the services platform 125, the one or more services 127, or the content providers 129.

By way of example, the vehicles 101, the UEs 115, the mapping platform 107, the services platform 125, and the content providers 129 communicate with each other and other components of the communication network 118 using well known, new or still developing protocols. In this context, a protocol includes a set of rules defining how the network nodes within the communication network 118 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

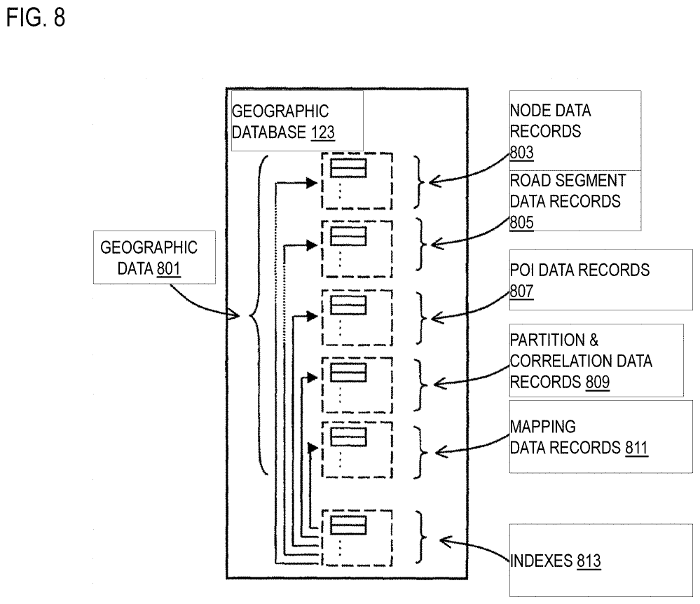

FIG. 8 is a diagram of a geographic database (such as the database 115), according to example embodiment(s). In one embodiment, the geographic database 123 includes geographic data 801 used for (or configured to be compiled to be used for) mapping and/or navigation-related services, such as for video odometry based on the parametric representation of lanes include, e.g., encoding and/or decoding parametric representations into lane lines. In one embodiment, the geographic database 123 include high resolution or high definition (HD) mapping data that provide centimeter-level or better accuracy of map features. For example, the geographic database 123 can be based on Light Detection and Ranging (LiDAR) or equivalent technology to collect billions of 3D points and model road surfaces and other map features down to the number lanes and their widths. In one embodiment, the mapping data (e.g., mapping data records 811) capture and store details such as the slope and curvature of the road, lane markings, roadside objects such as signposts, including what the signage denotes. By way of example, the mapping data enable highly automated vehicles to precisely localize themselves on the road.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 123.

“Node”— A point that terminates a link.

“Line segment”— A straight line connecting two points.

“Link” (or “edge”)— A contiguous, non-branching string of one or more line segments terminating in a node at each end.

“Shape point”— A point along a link between two nodes (e.g., used to alter a shape of the link without defining new nodes).

“Oriented link”— A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 123 follows certain conventions. For example, links do not cross themselves and do not cross each other except at a node. Also, there are no duplicated shape points, nodes, or links. Two links that connect each other have a common node. In the geographic database 123, overlapping geographic features are represented by overlapping polygons. When polygons overlap, the boundary of one polygon crosses the boundary of the other polygon. In the geographic database 123, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 123 includes node data records 803, road segment or link data records 805, POI data records 807, partition and correlation data records 809, mapping data records 811, and indexes 813, for example. More, fewer or different data records can be provided. In one embodiment, additional data records (not shown) can include cartographic (“carto”) data records, routing data, and maneuver data. In one embodiment, the indexes 813 may improve the speed of data retrieval operations in the geographic database 123. In one embodiment, the indexes 813 may be used to quickly locate data without having to search every row in the geographic database 123 every time it is accessed. For example, in one embodiment, the indexes 813 can be a spatial index of the polygon points associated with stored feature polygons.

In exemplary embodiments, the road segment data records 805 are links or segments representing roads, streets, or paths, as can be used in the calculated route or recorded route information for determination of one or more personalized routes. The node data records 803 are end points (such as intersections) corresponding to the respective links or segments of the road segment data records 805. The road link data records 805 and the node data records 803 represent a road network, such as used by vehicles, cars, and/or other entities. Alternatively, the geographic database 123 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 123 can include data about the POIs and their respective locations in the POI data records 807. The geographic database 123 can also include data about places, such as cities, towns, or other communities, and other geographic features, such as bodies of water, mountain ranges, etc. Such place or feature data can be part of the POI data records 807 or can be associated with POIs or POI data records 807 (such as a data point used for displaying or representing a position of a city). In one embodiment, certain attributes, such as lane marking data records, mapping data records and/or other attributes can be features or layers associated with the link-node structure of the database.

In one embodiment, the geographic database 123 can also include the partition and correlation data records 809 for storing partition data, correlation data, training data, prediction models, annotated observations, computed featured distributions, sampling probabilities, and/or any other data generated or used by the system 100 according to the various embodiments described herein. By way of example, the partition and correlation data records 809 can be associated with one or more of the node records 803, road segment records 805, and/or POI data records 807 to support localization or visual odometry based on the features stored therein and the corresponding estimated quality of the features. In this way, the partition and correlation data records 809 can also be associated with or used to classify the characteristics or metadata of the corresponding records 803, 805, and/or 807.

In one embodiment, as discussed above, the mapping data records 811 model road surfaces and other map features to centimeter-level or better accuracy. The mapping data records 811 also include lane models that provide the precise lane geometry with lane boundaries, as well as rich attributes of the lane models. These rich attributes include, but are not limited to, lane traversal information, lane types, lane marking types, lane level speed limit information, and/or the like. In one embodiment, the mapping data records 811 are divided into spatial partitions of varying sizes to provide mapping data to vehicles 101 and other end user devices with near real-time speed without overloading the available resources of the vehicles 101 and/or devices (e.g., computational, memory, bandwidth, etc. resources).

In one embodiment, the mapping data records 811 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the mapping data records 811.

In one embodiment, the mapping data records 811 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

In one embodiment, the geographic database 123 can be maintained by the content provider 129 in association with the services platform 125 (e.g., a map developer). The map developer can collect geographic data to generate and enhance the geographic database 123. There can be different ways used by the map developer to collect data. These ways can include obtaining data from other sources, such as municipalities or respective geographic authorities. In addition, the map developer can employ field personnel to travel by vehicle (e.g., vehicles 101 and/or UEs 115) along roads throughout the geographic region to observe features and/or record information about them, for example. Also, remote sensing, such as aerial or satellite photography, can be used.

The geographic database 123 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle 101 or a UE 115, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for identifying partitions associated with erratic pedestrian behaviors and their correlations to points of interest may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

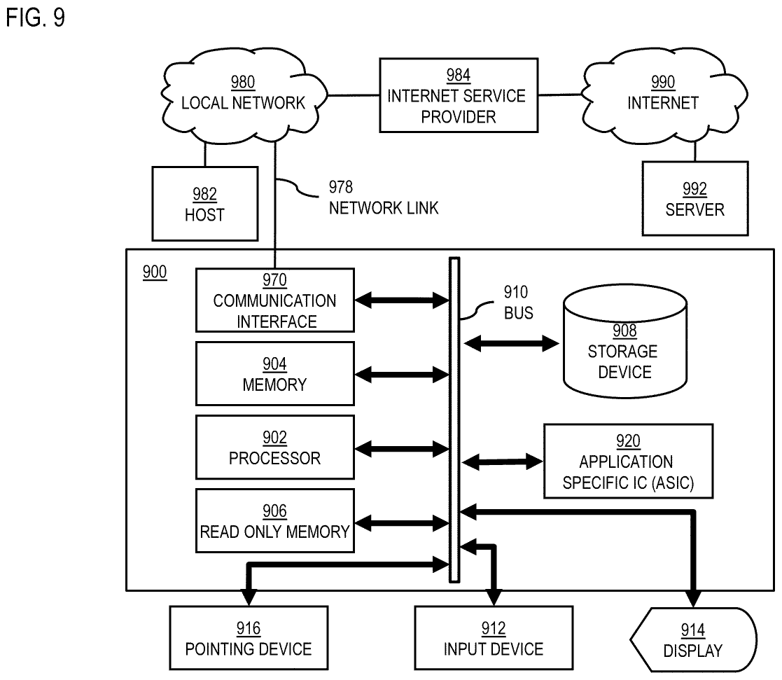

FIG. 9 illustrates a computer system 900 upon which an embodiment of the invention may be implemented. Computer system 900 is programmed (e.g., via computer program code or instructions) to identify partitions associated with erratic pedestrian behaviors and their correlations to points of interest as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 910 includes one or more parallel conductors of information so that information is transferred quickly among devices coupled to the bus 910. One or more processors 902 for processing information are coupled with the bus 910.

A processor 902 performs a set of operations on information as specified by computer program code related to identifying partitions associated with erratic pedestrian behaviors and their correlations to points of interest. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or other dynamic storage device, stores information including processor instructions for identifying partitions associated with erratic pedestrian behaviors and their correlations to points of interest. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for identifying partitions associated with erratic pedestrian behaviors and their correlations to points of interest, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT) or a liquid crystal display (LCD), or plasma screen or printer for presenting text or images, and a pointing device 916, such as a mouse or a trackball or cursor direction keys, or motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 118 for identifying partitions associated with erratic pedestrian behaviors and their correlations to points of interest to the vehicles 101 and/or UEs 115.

The term computer-readable medium is used herein to refer to any medium that participates in providing information to processor 902, including instructions for execution. Such a medium may take many forms, including, but not limited to, non-volatile media, volatile media and transmission media. Non-volatile media include, for example, optical or magnetic disks, such as storage device 908. Volatile media include, for example, dynamic memory 904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system can be deployed in various configurations within other computer systems, e.g., host 982 and server 992.

FIG. 10 illustrates a chip set 1000 upon which an embodiment of the invention may be implemented. Chip set 1000 is programmed to identify partitions associated with erratic pedestrian behaviors and their correlations to points of interest as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to identify partitions associated with erratic pedestrian behaviors and their correlations to points of interest. The memory 1005 also stores the data associated with or generated by the execution of the inventive steps.

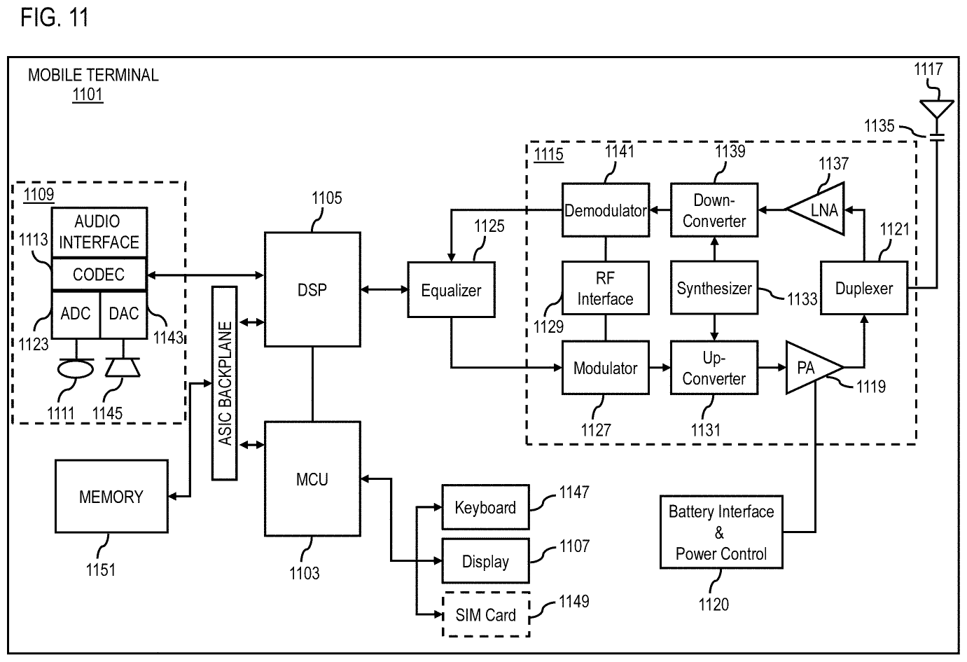

FIG. 11 is a diagram of exemplary components of a mobile terminal 1101 (e.g., handset or vehicle or part thereof) capable of operating in the system of FIG. 1, according to example embodiment(s). Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile station functions that offer automatic contact matching. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile station 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103—which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile station 1101 to identify partitions associated with erratic pedestrian behaviors and their correlations to points of interest. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the station. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile station 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1151 may be, but not limited to, a single memory, CD, DVD, ROM, RAM, EEPROM, optical storage, or any other non-volatile or non-transitory storage medium capable of storing digital data.

An optionally incorporated SIM card 1149 carries, for instance, important information, such as the cellular phone number, the carrier supplying service, subscription details, and security information. The SIM card 1149 serves primarily to identify the mobile station 1101 on a radio network. The card 1149 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving, by one or more processors from one or more sensors, sensor data associated with a geographic area;
based on the sensor data, determining, by the one or more processors, one or more pedestrian-behavior parameters respectively for one or more partitions, wherein each respective partition of the one or more partitions represents a respective subarea of the geographic area, a respective time period, or a combination thereof;
identifying, by the one or more processors, at least one erratic partition from the one or more partitions based on determining that a respective pedestrian-behavior parameter associated with the at least one erratic partition deviates from a baseline pedestrian-behavior parameter by at least a threshold extent;
determining, by the one or more processors, a correlation of the at least one erratic partition to at least one map feature of a geographic database; and
providing, by the one or more processors, the correlation as an output.

2. The method of claim 1, wherein a given pedestrian-behavior parameter corresponds to a digital measurement or representation of a particular behavior by one or more pedestrians.

3. The method of claim 1, further comprising:
generating a mapping user interface that presents a representation of the at least one erratic partition, the correlation of the at least one erratic partition to at least one map feature, or a combination thereof.

4. The method of claim 1, further comprising:
determining one or more instructions for operating an autonomous vehicle based on the at least one erratic partition, the correlation of the at least one erratic partition to at least one map feature, or a combination thereof.

5. The method of claim 4, wherein the one or more instructions include at least one of:
reducing speed within a threshold proximity of the at least one map feature, the subarea associated with the at least one erratic partition, or a combination thereof;
re-routing to avoid the at least one map feature, the subarea associated with the at least one erratic partition, or a combination thereof;
changing a lane to avoid pedestrian traffic within the threshold proximity of the at least one map feature, the subarea associated with the at least one erratic partition, or a combination thereof;
returning to a starting point;
refusing to drive within the threshold proximity of the at least one map feature, the subarea associated with the at least one erratic partition, or a combination thereof;
changing a vehicle type to perform a trip within the threshold proximity of the at least one map feature, the subarea associated with the at least one erratic partition, or a combination thereof;
recommending an alternative destination; or
recommending an alternative time to perform the trip within the threshold proximity of the at least one map feature, the subarea associated with the at least one erratic partition, or a combination thereof.

6. The method of claim 1, wherein the map feature is a point of interest, the method further comprising:
computing an optimal time for opening the point of interest based on determining a partition corresponding to a respective time period during which the deviation of the respective pedestrian-behavior parameter from the baseline pedestrian-behavior parameter is associated with a target pedestrian safety value.

7. The method claim 1, further comprising:
determining one or more recommended traffic management actions based on the at least one erratic partition, the correlation of the at least one erratic partition to at least one map feature, or a combination thereof; and
presenting the one or more recommended traffic management actions in a user interface of a device.

8. The method of claim 7, wherein the one or more recommended traffic management actions includes at least one of:
influencing pedestrian traffic flow within a threshold proximity of the at least one map feature, the subarea associated with the at least one erratic partition, or a combination thereof;
adapting a public transport schedule within the threshold proximity of the at least one map feature, the subarea associated with the at least one erratic partition, or a combination thereof;
adapting a traffic light timing within a threshold proximity of the at least one map feature, the subarea associated with the at least one erratic partition, or a combination thereof;
placing police within a threshold proximity of the at least one map feature, the subarea associated with the at least one erratic partition, or a combination thereof;
creating pedestrian infrastructure within a threshold proximity of the at least one map feature, the subarea associated with the at least one erratic partition, or a combination thereof; or
providing a ranked list of the one or more recommended traffic management actions based on a pedestrian safety parameter.

9. The method of claim 1, wherein the correlation is determined further based on a population density, an origin/destination matrix of one or more pedestrian paths represented in the sensor data, or a combination thereof.

10. The method of claim 1, wherein the correlation is determined based on at least one isoline generated from a location of the at least one map feature, based on a starting or end point of a pedestrian path indicated in the sensor data, or a combination thereof.

11. The method of claim 1, wherein the sensor data includes probe data indicating a speed, a heading, a heading change, or a combination thereof as the one or more features of the pedestrian of the behavior.

12. The method of claim 1, further comprising:
classifying the pedestrian behavior into a behavior type,
wherein the deviation of the pedestrian behavior is determined with respect to the behavior type, and
wherein the behavior type includes, at least in part, a running behavior, a falling behavior, an inattention behavior, an illegal pedestrian behavior, or a combination thereof.

13. The method of claim 1, wherein the sensor data is collected from a first time epoch, and wherein the baseline pedestrian-behavior parameter is determined from other sensor data collected from a second time epoch that is different from the first time epoch.

14. The method of claim 1, wherein the one or more features associated with the pedestrian behavior are input to a trained machine learning model to identify the at least one erratic partition, the correlation, or a combination thereof.

15. An apparatus comprising:
at least one processor; and
at least one memory including computer program code for one or more programs,
the at least one memory and the computer program code configured to, with the at least one processor, cause the apparatus to perform at least the following,
receive, from one or more sensors, sensor data associated with a geographic area;
based on the sensor data, determine one or more pedestrian-behavior parameters respectively for one or more partitions, wherein each respective partition of the one or more partitions represents a respective subarea of the geographic area, a respective time period, or a combination thereof;
identify at least one erratic partition from the one or more partitions based on determining that a respective pedestrian-behavior parameter associated with the at least one erratic partition deviates from a baseline pedestrian-behavior parameter by at least a threshold extent;
determine a correlation of the at least one erratic partition to at least one map feature of a geographic database; and
provide the correlation as an output.

16. The apparatus of claim 15, wherein the apparatus is further caused to:
determine one or more instructions for operating an autonomous vehicle based on the at least one erratic partition, the correlation of the at least one erratic partition to at least one map feature, or a combination thereof.

17. The apparatus of claim 15, wherein the map feature is a point of interest, and the apparatus is further caused to:
compute an optimal time for opening the point of interest based on determining a temporal partition during which the deviation of the respective pedestrian-behavior parameter from the baseline pedestrian-behavior parameter is associated with a target pedestrian safety value.

18. A non-transitory computer readable storage medium non-transitory computer-readable storage medium carries one or more sequences of one or more instructions which, when executed by one or more processors, cause, at least in part, an apparatus to perform:
receiving, from one or more sensors, sensor data associated with a geographic area;
based on the sensor data, determining one or more pedestrian-behavior parameters respectively for one or more partitions, wherein each respective partition of the one or more partitions represents a respective subarea of the geographic area, a respective time period, or a combination thereof;
identifying at least one erratic partition from the one or more partitions based on determining that a respective pedestrian-behavior parameter associated with the at least one erratic partition deviates from a baseline pedestrian-behavior parameter by at least a threshold extent;
determining a correlation of the at least one erratic partition to at least one map feature of a geographic database; and
providing the correlation as an output.

19. The non-transitory computer-readable storage medium of claim 18, wherein the apparatus is further caused to perform:
determining one or more instructions for operating an autonomous vehicle based on the at least one erratic partition, the correlation of the at least one erratic partition to at least one map feature, or a combination thereof.

20. The non-transitory computer-readable storage medium of claim 18, wherein the map feature is a point of interest, and the apparatus is further caused to perform:
computing an optimal time for opening the point of interest based on determining a temporal partition during which the deviation of the respective pedestrian-behavior parameter from the baseline pedestrian-behavior parameter is associated with a target pedestrian safety value.
